(19) United States
(12) Patent Application Publication
(10) Pub. No.: US 2017/0282145 A1
(43) Pub. Date: Oct. 5, 2017

(54) Microfluidic Device for the Generation of Combinatorial Samples

(71) Applicant: European Molecular Biology Laboratory, Heidelberg (DE)

(72) Inventors: Christoph Merten, Heidelberg (DE); Dominic Eicher, Heidelberg (DE); Ramesh Utharala, Miryalaguda (IN)

(21) Appl. No.: 15/513,826

(22) PCT Filed: Sep. 7, 2015
(86) PCT No.: PCT/EP2015/070400

§ 371 Date: Mar. 23, 2017

(30) Foreign Application Priority Data
Sep. 25, 2014 (EP) 14186463.7

(51) Int. Cl. B01J 19/00; B01F 5/04; B01F 3/08; B01L 3/00; B01F 13/00

(52) U.S. Cl. CPC B01J 19/0046; B01L 3/502784; B01L 3/502738; B01L 3/502746; B01L 3/502715; B01F 13/0061; B01F 3/0807; B01F 5/0471; B01L 2200/0673; B01L 2300/0867; B01J 2219/00389; B01J 2219/00547; B01J 2219/00743; B01J 2219/00599; B01F 2215/0037

(57) ABSTRACT

The present disclosure relates to a microfluidic device and a method allowing the generating and screening of combinatorial samples. A microfluidic device for producing droplets of at least one sample into an immiscible phase is provided, the device comprising a droplet maker connecting an immiscible phase channel and a sample channel having at least one sample inlet connected to at least one sample inlet channel injecting the at least one sample into the sample channel, wherein the injection of the at least one sample is controlled by at least one sample valve, so that the at least one sample flows either towards a sample waste outlet or into the at least one sample inlet channel, wherein different sample inlet channel of the at least one sample inlet channel have the same hydrodynamic resistance resulting from the length, height and width of each sample inlet channel upstream of the droplet maker.

### FIELD OF THE INVENTION

The present disclosure relates to a microfluidic device and a method allowing the generating and screening of combinatorial samples.

### BACKGROUND OF THE INVENTION

Microfluidic devices consist typically of channel networks with channel dimensions of 10-500 μm in which liquids can be actuated by different means. More sophisticated microfluidic analysis systems have been developed using polymers with the purpose of miniaturizing existing lab scale experimental setups, to reduce sample reagent consumption and thereby cost, but also to gain sensitivity, throughput and multiplexing capabilities.

One of the basic technologies for modern microfluidics was developed in the 1990s and has been termed soft lithography (Xia and Whitesides, 1998). It is based on earlier photolithographic techniques developed to fabricate microelectronic devices (Nall and Lathrop, 1958). Soft lithography allows fast prototyping of new microfluidic chip designs by replica folding. Briefly, it allows repetitive manufacture of identical microfluidic chips by using micro scale structures patterned onto a silicon wafer as a negative mold. The time required from mold fabrication to the use of a finished microfluidic chip is at most one day. Molds are filled with polydime-thylsiloxane (PDMS) and baked. The cured PDMS chip can be cut out using a scalpel. Molds can be re-filled with PDMS and thus can be reused many times (Duffy et al., 1998). It has many advantages when used for microfluidic chip production in the context of biological and biomedical applications. The cured polymer is biocompatible and highly gas permeable, which allows the culturing of cells on-chip and the performance of many biochemical assays. Since PDMS has optical properties similar to that of glass, microfluidic devices made from this material are transparent and processes carried out on-chip can be monitored directly under a standard light microscope. Additionally, it is very flexible and easy to handle which makes it very amenable to use in the development of new prototype chips (Xia and Whitesides, 1998).

WO 2007/081386 provides a microfluidic channel for mixing and investigating aqueous phase droplets encapsulated in an oil stream.

A publication of Shaojiang Zeng et al. “Microvalve-actuated precise control of individual droplets in microfluidic devices”, LabChip, May 21, 2009; 9(10): 1340-1343 describes an example for the generation of sequences of individual droplets separated by an immiscible oil in a microfluidic channel. A droplet marker is described that is capable of generating four different droplet species that can be fused one by one in a combinatorial fashion. While in theory this approach allows for the generation of many mixtures of different compounds (that can be screened for a desired effect or exploited for on-chip synthesis of compound libraries) the system has several limitations: The system is dependent on droplet fusion and only allows for the generation of combinatorial droplet pairs; The system is driven by negative pressure. All flow is generated by aspirating from the outlet resulting in different droplet sizes for the different compounds when applying constant valve opening times. Even though this can be compensated in theory by adjusting the individual valve opening times, only a poor level of control can be achieved. Since each infused compound needs a specific valve opening time, it seems very challenging to systematically generate all possible droplet pairs (and synchronize the generation of the individual droplets to allow for pairing). In conclusion, the system can be hardly scaled up (the working principle was shown for 4 infused compounds, only, and solely two droplet species were fused). Furthermore, a negative pressure driven system has strict limitations in terms of the maximum flow rates and hence the throughput.

EP 1 601 874 describes the use of mechanical devices such as a Braille-display for closing and opening valves in a microfluidic system.

It is an object of the present disclosure to overcome at least one of the disadvantages of prior art.

### SUMMARY OF THE INVENTION

The present disclosure provides a microfluidic device for producing droplets of at least one sample into an immiscible phase, the device comprising a droplet maker connecting an immiscible phase channel and a sample channel having at least one sample inlet connected to at least one sample inlet channel injecting the at least one sample into the sample channel, wherein the injection of the at least one sample is controlled by at least one sample valve, so that the at least one sample flows either towards a sample waste outlet or into the at least one sample inlet channel, wherein different sample inlet channel of the at least one sample inlet channel have the same hydrodynamic resistance resulting from the length, height and width of each sample inlet channel upstream of the droplet maker.

The at least one sample inlet channel may have a sample fluidic resistor to adjust its length. It is obvious for a person skilled in the art that the hydrodynamic resistance of a channel is related to the parameters of length, height and width of a channel. Thus, a person ordinary skilled in the art will be able without undue burden to determine the hydrodynamic resistance of a particular channel or tubing.

The at least one valve may be connected to a pressurized sample reservoir to allow the sample to flow into the microfluidic device. In this embodiment, the at least one valve is used to allow samples stored in a pressurized sample reservoir to flow into the microfluidic device or chip.

The length, height and width of the immiscible phase channel upstream of the droplet maker have also to be taken into account to ensure a higher hydrodynamic resistance of the immiscible phase channel than the sample channel to avoid that the at least one sample preferably enters the immiscible phase channel. Again, a person ordinary skilled in the art will easily be able to choose parameters ensuring the intended resistance ratio.

One possibility to ensure a higher resistance in the immiscible phase channel is an immiscible phase fluidic resistor of the immiscible phase channel upstream of the droplet maker to ensure a higher resistance of the immiscible phase channel than the resistance of the sample channel to avoid that the at least one sample can enter the immiscible phase channel.

It is further intended that the sample droplets flow into an outlet channel and that a read-out channel can be connected to the outlet channel, wherein the read-out channel is a separable tubing. Thus, read-out channels can be filled with droplets or a sequence of droplets like a binary code and the read-out channel can be separated after finalizing the respective sequence or barcode.

The microfluidic device of the instant disclosure may have additional immiscible phase inlets directly at a transition point where samples are flushed out of at least one sample storage reservoir into a second microfluidic device. The at least one sample storage reservoir may be a tubing or microwell plate.

It is intended that the diameter of the at least one sample storage reservoir is at least twice of the diameter of the read-out channel.

Further, the additional immiscible phase inlets can be arranged as additional outer channels or channels arranged coaxially with the sample storage.

The at least one sample can be at least one of an aqueous solution, an organic solvent or a combination thereof and the immiscible phase may comprise oil like mineral oil, fluorinated oil or any other liquid not miscible with an aqueous liquid, organic solvent or a combination thereof. It is within the scope of the present disclosure that different immiscible phase can be used, like different types of oil or immiscible phases having different properties, for example different optical properties.

The microfluidic device may have a read-out module for analysing the sample droplet or sequence of sample droplets in the outlet channel or in the read-out channel. Alternatively a separable read-out channel can be transferred to an external read-out device.

Another object of the present disclosure is a method for providing a sequence of droplets of at least one sample, the method comprising:

providing at least two compounds to a microfluidic device;

producing at least one combinatorial sample out of the at least two compounds having a specific mixture of the at least two compounds;

injecting the at least one combinatorial sample into a microfluidic device;

generating at least one droplet of the at least one combinatorial sample in an immiscible phase; and

separating the at least one droplet with at least one immiscible phase;

providing at least on priming droplet in front of the first of the at least one droplet of the at least one combinatorial sample.

The method of the present disclosure can be used to generate a sequence of droplets comprising different combinatorial samples, wherein a sequence of droplets may comprise at least 50 droplets.

The method of the present disclosure may comprise the preparation of a priming droplet or a plurality of priming droplets, which comprises the solvent of the at least one combinatorial sample or only one of the at least two compounds for preparing the combinatorial sample.

Further, the at least one compound of the at least two compounds may be a prokaryotic or eukaryotic cell or wherein the at least one combinatorial sample comprises one prokaryotic or eukaryotic cell.

The at least one compound of the at least two compounds may be aspirated or transferred from a storage reservoir.

The combinatorial sample may be transferred from a storage reservoir into a read-out channel having a diameter, which is no more than half of the diameter of the storage reservoir

It is within the scope of the present disclosure that the droplets may be produced with a significantly smaller diameter than the one of the outlet channel or read-out channel and wherein the droplets are confined or separated from droplets containing a different sample composition using plugs of a third immiscible phase having a diameter significantly above the diameter of the reservoir to space out the droplets.

The at least one compound may be aspirated from microwell plates for delivery to a microfluidic device using a miscible carrier phase.

Aspirating the at least one compound can be synchronized with the valves of the microfluidic device. The synchronization ensures that droplets or plugs contain only pure samples or samples containing additional substrates.

Another way to produce only the intended samples is that only a medium section of the aspirated at least one compound will be used.

The method of the present disclosure comprises further the generation of an optical identifier between optical barcodes, wherein optical barcode comprises sequential droplet sequences using different properties of the droplets and wherein the end of each optical barcode is marked by droplets having a unique composition.

Further, a droplet or a plurality of droplets may be used to produce a unique signal different from the signals used for the generation of individual digits of a sequential barcode.

Prior to injecting the at least one combinatorial sample into a microfluidic device the remains of a previous combinatorial sample may be flushed into the droplet maker using the following combinatorial sample to produce a waste plug followed by transferring all aqueous liquids to the waste while the immiscible phase is still injected into the droplet maker so that a spacer of the immiscible phase separates the waste plug from the following combinatorial sample.

The outlet channel or read-out channel can be filled with a sequence of priming droplets prior to generating droplets of a sample to ensure that the filled outlet or read-out channel provides already the conditions during the production of droplets of samples.

### BRIEF DESCRIPTION OF THE FIGURES

Examples and embodiments of the present disclosure will now be described and shown in the following figures. It is obvious for a person ordinary skilled in the art, that the present disclosure is not limited to the shown embodiments. It shows:

FIG. 1 Schematically depiction of providing optimal start conditions.

FIG. 2 Schematic illustration of one embodiment of the invention.

FIG. 3 Schematic depiction of a 2D and 3D configuration for injecting additional sheath oil.

FIG. 4 Comparison of read-out of multi-cell droplets and single cell droplets.

FIG. 5 Schematic depiction of adding an end of barcode signal.

FIG. 6 Encapsulation of combinatorial samples avoiding cross-contamination.

FIG. 7 Encapsulation of homogeneously concentrated compounds delivered by an auto sampler in dispersed form spaced out by a miscible carrier phase.

### DETAILED DESCRIPTION OF THE INVENTION

The present disclosure provides a microfluidic device allowing the generation and screening of combinatorial samples in a high throughput fashion. Starting with a number of n inlets (into which n different compounds can be injected) a total of up to 2ⁿ−1 chemically distinct samples can be generated in an automated fashion.

All channels providing a liquid to the droplet maker are arranged “upstream” of the droplet maker within the meaning of the instant disclosure. The outlet channel transporting the droplets or sequence of droplets is arranged “downstream” of the droplet maker. The terms droplets or plugs are used synonymously.

An aqueous liquid within the meaning of the present disclosure comprises every liquid that is miscible with water. In contrary, the immiscible phase comprises every liquid that is not miscible with water, like oil.

The device of the present disclosure can be used for generating an optical barcoding system for the newly generated combinatorial samples, hence drastically facilitating downstream screening application (e.g. screening the samples for biological effects). The technology is very useful for a variety of applications including stem cell differentiation, combinatorial drug screens and combinatorial chemistry.

Document WO2013037962 discloses a device and a sample barcoding approach. The instant disclosure provides further details of the device which are novel and inventive over the disclosure of WO2013037962.

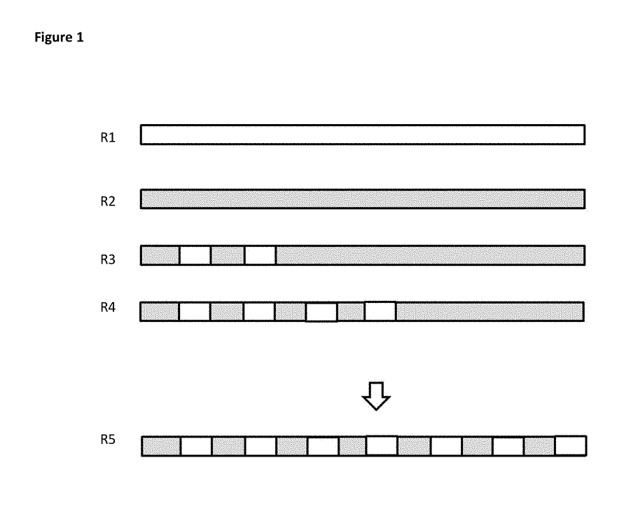

FIG. 1 shows in R1 to R4 different start condition before analyzing a sequence of droplets. The resistance (R) of a reservoir such as tubing depends on the inner medium and is particularly high for two-phase systems. R1 shows a tubing filled with air, R2 shows a tubing filled with liquid, R3 shows a tubing filled with only a few plugs and R4 shows a tubing filled with many plugs. Basically, the hydrodynamic resistance in the setups shown in R1 to R4 is different. As a consequence, the tubing has to be filled with “dummy” plugs or droplets before the samples to be analyzed are generated to achieve a more constant resistance throughout the entire experiment (R5).

After the combinatorial samples are generated using e.g. a braille display chip, they are stored in a sequential fashion either in a tubing, capillary or microfluidic channel. In the beginning of the experiment this reservoir does not contain any plugs, but rather air or any priming liquid such as oil or water. However, moving this single-phase system typically requires a lower backpressure compared to moving an array of plugs (a two-phase system). Hence during the course of the experiment, in which more and more plugs are generated and injected into the reservoir, the backpressure changes resulting in inhomogeneous sample sizes and inhomogeneous fractions of individual compounds within mixtures. This effect can be overcome by priming the system with “priming plugs” (e.g. water plugs in oil), generated in the same way as the later samples for analysis, so that only after the tubing has been filled completely with the priming plugs or droplets (or optionally even flushed for a longer time period), the assay samples for analysis are generated. The assay samples will experience a much lower change in back pressure over time (as the number of total plugs in the system remains almost constant) and hence hardly change in size.

Successful operation of the combinatorial Braille device (microfluidic device) requires careful adjustments of the resistances of all channels. For example, the channels for all aqueous samples should have the same resistance, which can be achieved by the use of resistors (to compensate for differences in length, width or height). Additionally, the channel downstream of the oil inlet must have a higher resistance than the channel between the drop maker (T-junction) and the sample outlet, as otherwise aqueous samples are occasionally pushed into the oil channel, changing the desired direction of flow (from the oil inlet to the sample outlet) inside the device.

The size of the aqueous plugs or droplets also varies if the sample channels upstream of the drop maker have significantly different resistances. This is the case for the geometry shown in WO2013037962 as the length for the disclosed channels differs significantly. The instant disclosure provides a microfluidic device (chip) with sample channels upstream of the drop maker having the same length. Thus, varying sample sizes and varying fractions of individual compounds are avoided within a mixture. A fluidic resistor at the inlet of the immiscible phase (oil) can be used to avoid that the aqueous samples (optionally injected at much higher flow rates as compared to the oil) enter the oil channel upon opening of the valves (referring to the valves that control the flow of aqueous samples towards the drop maker).

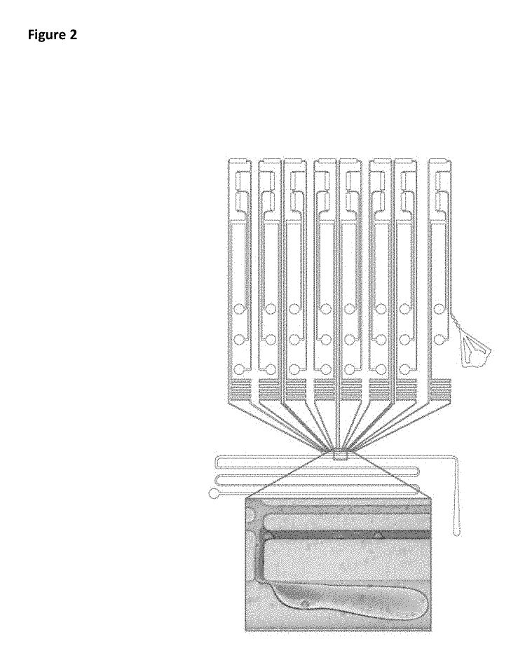

FIG. 2 shows a setup of a microfluidic device having fluidic resistors of the sample inlet channels 40 as well as a fluidic resistor of the immiscible phase channel 42. The fluidic resistors of the of the sample inlet channel 40 are used to adjust the same length for each sample inlet channel. The fluidic resistor of the immiscible phase 42 channel should ensure that the resistance of the immiscible phase channel is higher that the resistance of the outlet channel and/or read-out channel downstream of the droplet maker. Upstream of the fluidic resistors 40 are the sample inlets 25 and the waste outlet 30 arranged. On top of FIG. 2 the valves 20 are arranged in a so called valve module. A cell inlet 15 can be used to flush cells into the microfluidic device. The immiscble phase inlet 50 applies the immiscible phase 85.

The droplet maker 100 comprises a T-junction 35 in the embodiment of FIG. 1 as well as a sample channel 29 and sample inlet channel 27. A droplet 80 is formed in the immiscible phase 85

Many biological and chemical assays require the addition of further substrates to the samples after their initial generation. This has be done for instance after an incubation time to initiate a readout reaction based on fluorescence. Technically, this task can be achieved using a fusion module as described in by Clausell-Tormos et al. (Chem Biol. May 2008; 15(5):427-437). However, when using samples containing cells or high concentrations of protein, this approach is difficult, as wetting is frequently observed at the point where the samples exit the storage reservoir and enter the microfluidic fusion chip. The inventors discovered that this can be avoided by injecting additional carrier oil (acting similar to the sheath fluid in FACS applications) with a low concentration of surfactant at this point. Geometrically this requires additional outer channels (2D configuration) or a coaxial flow of oil (3D configuration) using an additional tubing around the reservoir into which oil is continuously injected and further flows into the microfluidic fusion chip, hence insulating the aqueous samples from the channel walls.

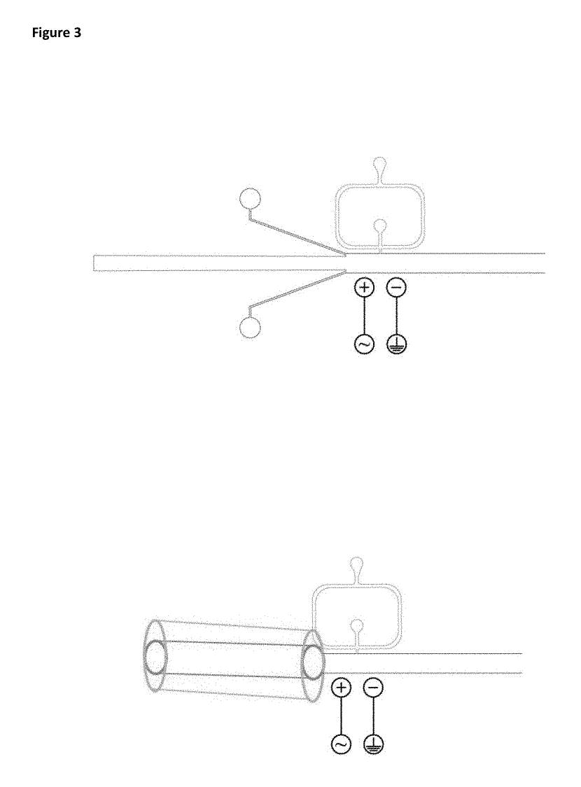

FIG. 3 shows schematically setups for the addition of additional substrates by additional immiscible phase inlets 120 to the samples. Such an addition requires a fusion step involving the injection of all sample plugs through a connection port for droplet fusion 130 into a second microfluidic device. Fusion electrodes 110 can be arranged at the fusion chamber 90 as well as the substrate droplet make 100. Wetting occurs frequently at the transition point from the tubing to the channel walls. This can be overcome by injecting additional “sheath oil” either in a 2D or 3D configuration (120 top and bottom).

When generating plugs that host cells, it is difficult to obtain equal cell numbers across all samples (Clausell-Tormos et al, Chem Biol. May 2008; 15(5):427-437). This may cause problems in drug screening applications, as a strong readout signal (e.g. in a cell-based fluorescence assay) could either be due to a particularly effective drug or simply to a sample with an extraordinary high number of cells. In theory, this problem can be overcome come by performing single cell assays: Using a cell density corresponding to less than one cell per plug volume, most plugs will contain either one or no cell. This allows omitting all samples showing only background signals (=empty plugs), while the plugs showing a signal intensity, which is significantly above background, will host most likely the same cell number (n=1). However, as single cell assays are subjected to biological variation, this approach requires a high number of replicates. Experimentally generating droplets, which are much smaller than the plugs described in WO2013037962 at high frequency, may solve this problem. However, due to the decreased size, these droplets would typically not keep a sequential order: If their diameter is smaller than the diameter of the reservoir, the different samples can shuffle, thus making it impossible to track the sample identity. However, this can be avoided by using larger mineral oil plugs (diameter significantly above the diameter of the reservoir) to space out the small droplets.

The samples are eventually flushed for the readout through a channel with a diameter comparable to that of the small droplets, so that each sample is measured individually without the possibility for two samples passing the detector at the same time. It is important to note that the diameter of the reservoir for incubation (tubing) cannot have such a small diameter, as this would result in resistances that cannot be handled experimentally. We hence suggest having a relatively large diameter (>100 μm) of the reservoir for incubation, while passing the samples through a narrow constriction (<100 μm) upstream or at the readout point.

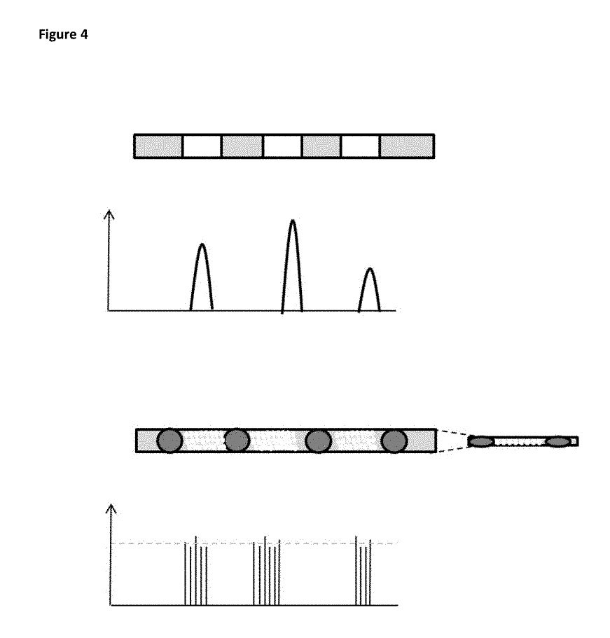

FIG. 4 shows in the upper part that plug hosting different cell numbers (A 68 cells; B 75 cells; C 53 cells) will cause different signal intensities in the readout. This can be overcome by single-cell analysis. If a particular sample has less cells, the number of positive peaks will be decreased, but their average intensity remains the same (bottom of FIG. 4). Experimentally this requires the use of large diameter reservoirs and small diameter readout channels for the signal read-out 150. The single cell droplets are spaced out with larger immiscible phase plugs 140.

It is possible to use a microfluidic device for a barcoding strategy of samples by making use of plugs containing different fluorophores (or concentrations thereof). As their sequence is kept constant throughout the entire experiment, samples can be used to write binary codes (e.g. high intensity=1; low intensity=0). It has been discovered that this type of barcoding becomes much more reliable when adding a unique signal for encoding the end of the barcode. This can be done by generating a sample with intermediate signal intensity or a completely different signal (color).

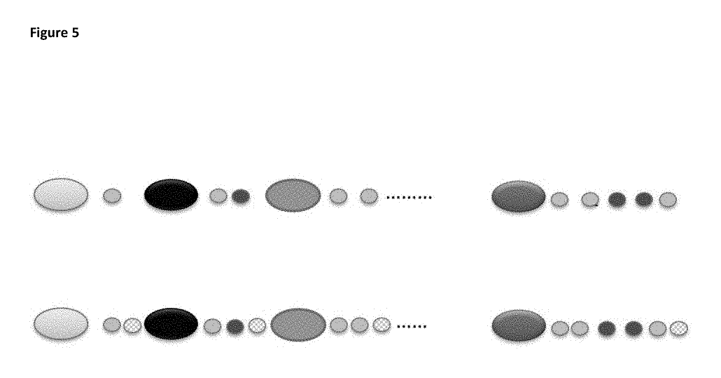

FIG. 5 shows that the readability of the binary barcodes (1 and 0) can be drastically improved by adding an additional “end of barcode” signal 230. This is particularly relevant as the number of digits per barcode is not constant, making it difficult to define the end of a barcode. Each barcode can be separated by immiscible phase plugs 200.

Cross-contamination may occur in microfluidic devices making use of channels through which different reagents are flushed sequentially (based on the mixture to be generated), This is particularly relevant, as each channel upstream of the droplet maker has a certain dead volume, which remains after the generation of a particular mixture. To overcome this problem, the present disclosure provides a method for flushing out these remains and encapsulating them into a so-called “waste plug” in between each sample mixture.

The method is based on splitting the generation of each new sample (each new combinatorial mixture) into two phases: First, the valve configuration for the generation of this particular mixture (VCᵢ) is set for just a very short time (a time period corresponding to less than the desired sample size for a given assay; e.g. 1s) during which the remains of the previous sample are flushed into the droplet maker (mixing with and contaminating the current sample). Then the valve configuration is switched so that all aqueous liquids are sent to the waste while oil is still injected into the droplet maker. In consequence, an oil spacer is generated physically separating this newly generated waste plug from the next sample. Now the valve configuration is switched back to VCᵢ. As the dead volume of the channels is now already filled with the desired mixture, no cross-contamination occurs and a plug with known sample composition is generated. Noteworthy, there is hardly any alternative native to this procedure: Flushing the channels with washing buffer in between each sample would not overcome the cross-contamination issue, as it would remain in the dead volume of the channel network as well, thus contaminating or at least diluting the next (i+1) sample.

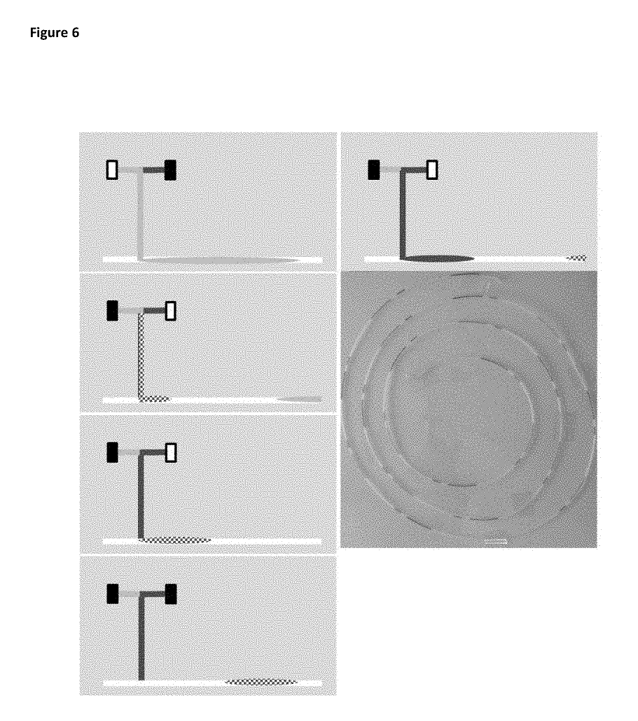

FIG. 6 shows the encapsulation of a combinatorial sample into droplets without significant cross-contamination between the samples. An open valve 300 allows the respective sample to enter the channel and a closed valve 310 will stop the respective sample from entering the channel. A1-A5: After the encapsulation of a particular first combinatorial sample 320 the channels upstream of the drop maker are still filled with this sample and droplets thereof 321. These remains can be eliminated by shortly flushing the channels with a second sample mixture 330, followed by the injection of only an immiscible phase like oil. In consequence a waste plug 341 is generated from the mixture of samples 340, while the channels upstream of the drop maker are filled with pure 330. Hence opening the valves for the generation of 330 again results in the generation of a pure new combinatorial sample droplet 331, without any significant contamination from the previous sample. Part B of FIG. 6 shows a sequence of waste and sample plugs generated as described in A1 to A5.

WO2013037962 also discloses the idea of sequentially injecting different compounds into at least one of the inlets of the combinatorial microfluidic chip. This can, for example, be achieved by connecting an auto sampler to the microfluidic chip. However, each compound aspirated by an auto sampler from microwell plates is transported to the microfluidic chip using a miscible carrier phase (e.g. buffer). This may cause two problems: The compound is diluted according to Tailor-Aris dispersion and furthermore the miscible phase is also injected into the combinatorial chip. However, for the generation of systematic combinatorial mixtures it is typically desirable dealing with pure, homogenously concentrated compounds. To achieve this, the beginning and end of each compound plug coming from the auto sampler can be truncated and sent to the waste (comp. FIG. 2). The instant disclosure provides a method installing a feedback loop between the auto sampler and the control of the braille display: Whenever the auto sampler injects a new compound pound into the tubing leading to the microfluidic chip, an electrical signal (relay signal) is send to the control software. After a constant delay in time for each compound, the dispersed compound plug arrives at the microfluidic chip, where its beginning and end is transferred to the waste by switching the valves accordingly (based on a pre-determined time sequence for the valve configurations). Due to the internal reference signal for each sample (the relay signal coming from the auto sampler), efficient synchronization between the two devices is guaranteed.

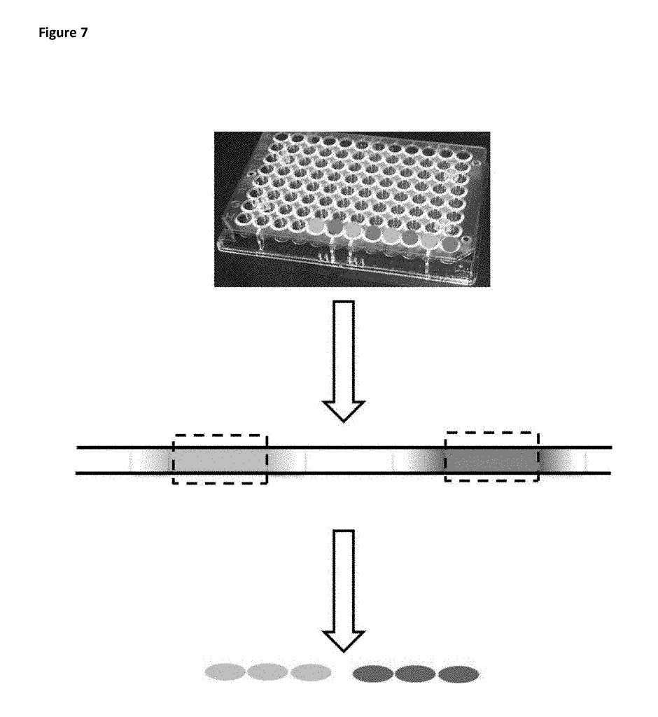

FIG. 7 shows the encapsulation of homogeneously concentrated compounds delivered by an auto sampler 400 in dispersed form spaced out by a miscible carrier phase. The (dispersed) beginning and end of each compound plug, as well as the spacer, can be sent to the waste by synchronizing the valve configuration of the braille display with the arrival of compound plugs at the microfluidic chip. Each time the auto sampler 400 injects a compound into the tubing leading to the microfluidic chip, an electrical signal serving as an internal reference point 450 is sent to the control software of the braille display. Only after a pre-determined delay in time 430 and only for a pre-determined duration 440, the valves are switched to allow for the delivery of the pure compound 421 and 441 to the drop maker. During all other times the valve configuration sends all liquid coming from the auto sampler to the waste. The arrow at the right side indicates the direction of flow.

### REFERENCE NUMBER LIST

0 droplet encoding 0
1 droplet encoding 1
15 cell inlet
20 valve
25 sample inlets
27 sample inlet channel
29 sample channel
30 waste outlet
35 T-junction
40 fluidic resistor
42 immiscible phase fluidic resistor
50 immiscible phase inlet
60 outlet channel
80 droplet channel
85 immiscible phase
90 fusion chamber
100 substrate droplet maker
110 fusion electrodes
120 additional immiscible phase inlets
130 connection port for droplet fusion
140 mineral oil
150 signal read-out
200 spacer
230 droplet encoding end of sequence
300 open valve
310 closed valve
320 first sample
321 droplet of first sample
330 second sample
331 droplet of second sample
340 mixture of first and second sample
341 droplet of mixture of first and second sample
350 immiscible phase
400 auto sample
410 valve control
421 droplet first sample
430 delay t_{w}
440 delivery second sample t_{d}
441 droplet second sample
450 electrical signal serving as an internal reference point

1. A microfluidic device for producing droplets of at least one sample into an immiscible phase, the device comprising:
a droplet maker connecting an immiscible phase channel and a sample channel having a plurality of sample inlet connected to a plurality of sample inlet channel injecting the at least one sample into the sample channel, wherein the injection of the at least one sample is controlled by a plurality of sample valves, so that the at least one sample flows either towards a sample waste outlet or into one of the plurality of sample inlet channels, wherein different ones of the plurality of sample inlet channels have the same hydrodynamic resistance resulting from the length, height and width of the sample inlet channel upstream of the droplet maker; and an outlet channel, wherein the hydrodynamic resistance of the outlet channel is lower than the hydrodynamic resistance of the immiscible phase channel.

2. The microfluidic device of claim 1, wherein ones of the plurality of sample inlet channels have a sample fluidic resistor to adjust length.

3. The microfluidic device of claim 1, further comprising an immiscible phase fluidic resistor of the immiscible phase channel upstream of the droplet maker to ensure a higher resistance of the immiscible phase channel than the resistance of the sample channel to avoid that the at least one sample can enter the immiscible phase channel.

4. The microfluidic device of claim 1, wherein the sample droplets flow into a read-out channel.

5. The microfluidic device of claim 3, comprising additional immiscible phase inlets, the additional immiscible phase inlets being located directly at a transition point where the droplets of the at least one sample are flushed out of the droplet maker into a second microfluidic device.

6. The microfluidic device of claim 4, wherein the diameter of the read-out channel is comparable in size to the droplets of the at least one sample.

7. The microfluidic device of claim 4, wherein the additional immiscible phase inlets are additional outer channels or channels arranged coaxially with the sample storage.

8. A method for providing a sequence of droplets of at least one sample, the method comprising:
providing at least two compounds to a droplet maker;
producing at least one combinatorial sample out of the at least two compounds having a specific mixture of the at least two compounds;
injecting the at least one combinatorial sample from the droplet maker into a first microfluidic device;
generating in the first microfluidic device at least one droplet of the at least one combinatorial sample in an immiscible phase; and
separating the at least one droplet with at least one immiscible phase;
providing at least one priming droplet in front of the first of the at least one droplet of the at least one combinatorial sample.

9. The method of claim 8, wherein the at least one combinatorial sample comprises preferably one prokaryotic or eukaryotic cell.

10. The method of claim 8, wherein at least one compound of the at least two compounds is aspirated or transferred from a storage reservoir.

11. The method of claim 8, wherein a combinatorial sample is transferred from a storage reservoir into a read-out channel having a diameter, which is no more than half of the diameter of the storage reservoir.

12. The method of claim 8, wherein the sequence of droplets are produced with a significantly smaller diameter than the outlet channel and wherein ones of the sequence of droplets are confined or separated from droplets containing a different sample composition using plugs of a third immiscible phase having a diameter significantly above the diameter of the reservoir to space out the ones of the sequence of droplets.

13. The method of claim 8, wherein directly at the transition point from the first microfluidic device to a second microfluidic device, additional immiscible phase inlets are used to flush the at least one sample into the second microfluidic device.

14. The method of claim 8, wherein aspirating the at least one compound is synchronized with the valves of the first microfluidic device so that only a medium section of the aspirated at least one compound is used for droplet making.

15. The method of claim 8, wherein an optical identifier is generated between optical barcodes, wherein optical barcode comprises sequential droplet sequences using different properties of the droplets and wherein the end of each optical barcode is marked by droplets having a unique composition.

16. The method of claim 8, wherein prior to injecting the at least one combinatorial sample into the first microfluidic device the remains of a previous combinatorial sample are flushed into the droplet maker using the following combinatorial sample to produce a waste plug followed by transferring all aqueous liquids to the waste while the immiscible phase is still injected into the droplet maker so that a spacer of the immiscible phase separates the waste plug from the following combinatorial sample.
